(19) United States
(12) Patent Application Publication
(10) Pub. No.: US 2026/0261363 A1
(43) Pub. Date: Sep. 3, 2026

(54) TRANSMISSION OF SYSTEM INFORMATION WITH PUNCTURING

(71) Applicant: Nokia Technologies Oy, Espoo (FI)

(72) Inventors: Sami-Jukka HAKOLA, Oulu (FI); Esa Tapani TIIROLA, Oulu (FI); Kari Juhani HOOLI, Oulu (FI); Jorma Johannes KAIKKONEN, Oulu (FI); Pasi Eino Tapio KINNUNEN, Oulu (FI)

(21) Appl. No.: 18/834,218

(22) PCT Filed: Jan. 31, 2022
(86) PCT No.: PCT/EP2022/052206

§ 371 Date: Jul. 29, 2024

(51) Int. Cl. H04L 1/00; H04L 5/00; H04W 56/00; H04W 72/231

(52) U.S. Cl. CPC H04L 1/0069; H04L 5/0051; H04W 56/0015; H04W 72/231

(57) ABSTRACT

This document discloses a solution for transmitting system information. According to an aspect, a method comprises: storing a mapping table comprising mapping information on demodulation reference signal sequences to puncturing patterns; determining, based on available bandwidth, that puncturing shall be applied to transmission of a system information block in order to fit the system information block to a frequency band having the available bandwidth; selecting, from the puncturing patterns, a first puncturing pattern to puncture at least one physical resource block to provide the available bandwidth for transmitting the system information block; selecting, on the basis of the mapping table, a first demodulation reference signal sequence mapped to the selected first puncturing pattern in the mapping table; and transmitting the system information block and the first demodulation reference signal sequence by using the available bandwidth.

### FIELD

Various embodiments described herein relate to the field of wireless communications and, particularly, to carry out punctured transmissions in a cellular communication system.

### BACKGROUND

It is anticipated that modern cellular communication systems (such as the 5G New Radio (NR) or future 5G-Advanced) shall support, in addition to default bandwidths (e.g. five Megahertz, MHz), narrowband communications on a narrower bandwidth. One such a use scenario is railway communications and public safety communications that are currently estimated to utilize a narrower frequency band than the smallest bandwidth supported by the modern cellular communication systems. For example, it has been assumed that NR below 5 MHz (e.g. from 3 MHz to 5 MHz) scenarios would be possible when transiting GSM-R (Global System for Mobile Communications for Railway) to the 5G New Radio or later evolution versions of the cellular communication system.

### BRIEF DESCRIPTION

Some aspects of the invention are defined by the independent claims.

Some embodiments of the invention are defined in the dependent claims.

The embodiments and features, if any, described in this specification that do not fall under the scope of the independent claims are to be interpreted as examples useful for understanding various embodiments of the invention. Some aspects of the disclosure are defined by the independent claims.

According to an aspect, there is provided an apparatus comprising means for performing: storing a mapping table comprising mapping information on demodulation reference signal sequences to puncturing patterns; determining, based on available bandwidth, that puncturing shall be applied to transmission of a system information block in order to fit the system information block to a frequency band having the available bandwidth; selecting, from the puncturing patterns, a first puncturing pattern to puncture at least one physical resource block to provide the available bandwidth for transmitting the system information block; selecting, on the basis of the mapping table, a first demodulation reference signal sequence mapped to the selected first puncturing pattern in the mapping table; and transmitting the system information block and the first demodulation reference signal sequence by using the available bandwidth.

In an embodiment, the first puncturing pattern and a second puncturing pattern mapped to a second demodulation reference signal sequence indicate, in the mapping table, puncturing of the same number of physical resource blocks but with different puncturing patterns, and wherein the means are configured to select the second demodulation reference signal sequence upon determining that said system information or other system information shall be transmitted by using the second puncturing pattern.

In an embodiment, a second puncturing pattern mapped to a second demodulation reference signal sequence in the mapping table indicates that no puncturing shall be applied, and wherein the means are configured to select the second demodulation reference signal sequence upon determining that said system information or other system information shall be transmitted without puncturing.

In an embodiment, the first demodulation reference signal sequence further indicates a first synchronization signal block index of multiple possible synchronization signal block indices, the first synchronization signal block index indicating a first transmission beam where a synchronization signal block comprising the first demodulation reference signal shall be transmitted; the second demodulation reference signal sequence further indicates a second synchronization signal block index of said multiple possible synchronization signal block indices, the second synchronization signal block index indicating a second transmission beam where a synchronization signal block comprising the second demodulation reference signal shall be transmitted; and the means are configured to transmit the system information and the first demodulation reference signal sequence in the first transmission beam and in the synchronization signal block having the first synchronization signal block index.

In an embodiment, the number of said multiple possible synchronization signal block indices is a multiple greater than one of a number of different transmission beams where the synchronization signal block can be transmitted, and wherein the mapping table provides a mapping between the multiple possible synchronization signal block indices and respective puncturing patterns comprising the first puncturing pattern and the second puncturing pattern.

In an embodiment, the system information comprises a master information block indicating a control resource set for a physical downlink control channel, and wherein the means are configured to transmit control information for further system information on the physical downlink control channel by using the same puncturing pattern as used for transmitting the master information block.

In an embodiment, the mapping table maps each demodulation reference signal sequence of the mapping table to a unique combination of a puncturing pattern and at least one of a synchronization signal block index, a half-frame index, and a channel bandwidth.

In an embodiment, the mapping table maps each demodulation reference signal sequence of the mapping table to a unique combination of the puncturing pattern, the synchronization signal block index, and the half-frame index, and wherein one of the synchronization signal block index and the half-frame index is the same for all demodulation reference signal sequences of the mapping table and the other one of the synchronization signal block index and the half-frame index varies between demodulation reference signal sequences of the mapping table.

In an embodiment, the mapping table maps at least four different puncturing patterns, comprising no puncturing.

According to an aspect, there is provided an apparatus comprising means for performing: storing a mapping table comprising mapping information on demodulation reference signal sequences to puncturing patterns, the mapping information mapping a first demodulation reference signal sequence to a first puncturing pattern indicating a first set of punctured physical resource blocks, and at least a second demodulation reference signal sequence to a second puncturing pattern indicating a second set of punctured physical resource blocks; receiving a signal comprising a demodulation reference signal sequence and system information and detecting the demodulation reference signal sequence; if the demodulation reference signal sequence is detected as the first demodulation reference signal sequence, detecting the system information on a set of physical resource blocks defining a first frequency band that excludes the first set of punctured physical resource blocks; and if the demodulation reference signal sequence is detected as the second demodulation reference signal sequence, detecting the system information on a set of physical resource blocks defining a second frequency band that excludes the second set of punctured physical resource blocks.

In an embodiment, the first puncturing pattern and second puncturing pattern indicate puncturing of the same number of punctured physical resource blocks.

In an embodiment, the second puncturing pattern indicates that no puncturing shall be applied, and wherein the second frequency band is thus broader than the first frequency band.

In an embodiment, the system information comprises a master information block indicating a control resource set for a physical downlink control channel, and wherein the means are configured to detect control information for further system information on physical resource blocks of the physical downlink control channel by using the same puncturing pattern as used for detecting the master information block.

In an embodiment, the first demodulation reference signal sequence further indicates a first synchronization signal block index of multiple possible synchronization signal block indices, the first synchronization signal block index indicating a first transmission beam where a synchronization signal block comprising the first demodulation reference signal shall be transmitted; the second demodulation reference signal sequence further indicates second synchronization signal block index of said multiple possible synchronization signal block indices, the second synchronization signal block index indicating a second transmission beam where a synchronization signal block comprising the second demodulation reference signal shall be transmitted.

In an embodiment, the number of said multiple possible synchronization signal block indices is a multiple greater than one of a number of different transmission beams where the synchronization signal block can be transmitted, and wherein the mapping table provides a mapping between the multiple possible synchronization signal block indices and respective puncturing patterns comprising the first puncturing pattern and the second puncturing pattern.

In an embodiment, the mapping table maps each demodulation reference signal sequence of the mapping table to a unique combination of a puncturing pattern and at least one of a synchronization signal block index, a puncturing pattern, a half-frame index, and a channel bandwidth.

In an embodiment, the mapping table maps each demodulation reference signal sequence of the mapping table to a unique combination of the puncturing pattern, the synchronization signal block index, and the half-frame index, and wherein one of the synchronization signal block index and the half-frame index is the same for all demodulation reference signal sequences of the mapping table and the other one of the synchronization signal block index and the half-frame index varies between demodulation reference signal sequences of the mapping table.

In an embodiment, the mapping table maps at least four different puncturing patterns, comprising no puncturing.

In an embodiment, the means comprises at least one processor and at least one memory storing instructions that cause said performance of the apparatus.

According to an aspect, there is provided a method comprising: storing a mapping table comprising mapping information on demodulation reference signal sequences to puncturing patterns; determining, based on available bandwidth, that puncturing shall be applied to transmission of a system information block in order to fit the system information block to a frequency band having the available bandwidth; selecting, from the puncturing patterns, a first puncturing pattern to puncture at least one physical resource block to provide the available bandwidth for transmitting the system information block; selecting, on the basis of the mapping table, a first demodulation reference signal sequence mapped to the selected first puncturing pattern in the mapping table; and transmitting the system information block and the first demodulation reference signal sequence by using the available bandwidth.

In an embodiment, the first puncturing pattern and a second puncturing pattern mapped to a second demodulation reference signal sequence indicate, in the mapping table, puncturing of the same number of physical resource blocks but with different puncturing patterns, and wherein the method comprises selecting the second demodulation reference signal sequence upon determining that said system information or other system information shall be transmitted by using the second puncturing pattern.

In an embodiment, a second puncturing pattern mapped to a second demodulation reference signal sequence in the mapping table indicates that no puncturing shall be applied, and wherein the method comprises selecting the second demodulation reference signal sequence upon determining that said system information or other system information shall be transmitted without puncturing.

In an embodiment, the first demodulation reference signal sequence further indicates a first synchronization signal block index of multiple possible synchronization signal block indices, the first synchronization signal block index indicating a first transmission beam where a synchronization signal block comprising the first demodulation reference signal shall be transmitted; the second demodulation reference signal sequence further indicates a second synchronization signal block index of said multiple possible synchronization signal block indices, the second synchronization signal block index indicating a second transmission beam where a synchronization signal block comprising the second demodulation reference signal shall be transmitted; and the method comprises transmitting the system information and the first demodulation reference signal sequence in the first transmission beam and in the synchronization signal block having the first synchronization signal block index.

In an embodiment, the number of said multiple possible synchronization signal block indices is a multiple greater than one of a number of different transmission beams where the synchronization signal block can be transmitted, and wherein the mapping table provides a mapping between the multiple possible synchronization signal block indices and respective puncturing patterns comprising the first puncturing pattern and the second puncturing pattern.

In an embodiment, the system information comprises a master information block indicating a control resource set for a physical downlink control channel, and wherein the method comprises transmitting control information for further system information on the physical downlink control channel by using the same puncturing pattern as used for transmitting the master information block.

In an embodiment, the mapping table maps each demodulation reference signal sequence of the mapping table to a unique combination of a puncturing pattern and at least one of a synchronization signal block index, a half-frame index, and a channel bandwidth.

In an embodiment, the mapping table maps each demodulation reference signal sequence of the mapping table to a unique combination of the puncturing pattern, the synchronization signal block index, and the half-frame index, and wherein one of the synchronization signal block index and the half-frame index is the same for all demodulation reference signal sequences of the mapping table and the other one of the synchronization signal block index and the half-frame index varies between demodulation reference signal sequences of the mapping table.

In an embodiment, the mapping table maps at least four different puncturing patterns, comprising no puncturing.

According to an aspect, there is provided a method comprising: storing a mapping table comprising mapping information on demodulation reference signal sequences to puncturing patterns, the mapping information mapping a first demodulation reference signal sequence to a first puncturing pattern indicating a first set of punctured physical resource blocks, and at least a second demodulation reference signal sequence to a second puncturing pattern indicating a second set of punctured physical resource blocks; receiving a signal comprising a demodulation reference signal sequence and system information and detecting the demodulation reference signal sequence; if the demodulation reference signal sequence is detected as the first demodulation reference signal sequence, detecting the system information on a set of physical resource blocks defining a first frequency band that excludes the first set of punctured physical resource blocks; and if the demodulation reference signal sequence is detected as the second demodulation reference signal sequence, detecting the system information on a set of physical resource blocks defining a second frequency band that excludes the second set of punctured physical resource blocks.

In an embodiment, the first puncturing pattern and second puncturing pattern indicate puncturing of the same number of punctured physical resource blocks.

In an embodiment, the second puncturing pattern indicates that no puncturing shall be applied, and wherein the second frequency band is thus broader than the first frequency band.

In an embodiment, the system information comprises a master information block indicating a control resource set for a physical downlink control channel, and wherein the method comprises detecting control information for further system information on physical resource blocks of the physical downlink control channel by using the same puncturing pattern as used for detecting the master information block.

In an embodiment, the first demodulation reference signal sequence further indicates a first synchronization signal block index of multiple possible synchronization signal block indices, the first synchronization signal block index indicating a first transmission beam where a synchronization signal block comprising the first demodulation reference signal shall be transmitted; the second demodulation reference signal sequence further indicates a second synchronization signal block index of said multiple possible synchronization signal block indices, the second synchronization signal block index indicating a second transmission beam where a synchronization signal block comprising the second demodulation reference signal shall be transmitted.

In an embodiment, the number of said multiple possible synchronization signal block indices is a multiple greater than one of a number of different transmission beams where the synchronization signal block can be transmitted, and wherein the mapping table provides a mapping between the multiple possible synchronization signal block indices and respective puncturing patterns comprising the first puncturing pattern and the second puncturing pattern.

In an embodiment, the mapping table maps each demodulation reference signal sequence of the mapping table to a unique combination of a puncturing pattern and at least one of a synchronization signal block index, a puncturing pattern, a half-frame index, and a channel bandwidth.

In an embodiment, the mapping table maps each demodulation reference signal sequence of the mapping table to a unique combination of the puncturing pattern, the synchronization signal block index, and the half-frame index, and wherein one of the synchronization signal block index and the half-frame index is the same for all demodulation reference signal sequences of the mapping table and the other one of the synchronization signal block index and the half-frame index varies between demodulation reference signal sequences of the mapping table.

In an embodiment, In an embodiment, the mapping table maps at least four different puncturing patterns, comprising no puncturing.

According to an aspect, there is provided a computer program product embodied on a computer-readable medium and comprising a computer program code readable by a computer, wherein the computer program code configures the computer to carry out a computer process comprising: storing a mapping table comprising mapping information on demodulation reference signal sequences to puncturing patterns; determining, based on available bandwidth, that puncturing shall be applied to transmission of a system information block in order to fit the system information block to a frequency band having the available bandwidth; selecting, from the puncturing patterns, a first puncturing pattern to puncture at least one physical resource block to provide the available bandwidth for transmitting the system information block; selecting, on the basis of the mapping table, a first demodulation reference signal sequence mapped to the selected first puncturing pattern in the mapping table; and causing transmission of the system information block and the first demodulation reference signal sequence by using the available bandwidth.

According to an aspect, there is provided a computer program product embodied on a computer-readable medium and comprising a computer program code readable by a computer, wherein the computer program code configures the computer to carry out a computer process comprising: storing a mapping table comprising mapping information on demodulation reference signal sequences to puncturing patterns, the mapping information mapping a first demodulation reference signal sequence to a first puncturing pattern indicating a first set of punctured physical resource blocks, and at least a second demodulation reference signal sequence to a second puncturing pattern indicating a second set of punctured physical resource blocks; receiving a signal comprising a demodulation reference signal sequence and system information and detecting the demodulation reference signal sequence; if the demodulation reference signal sequence is detected as the first demodulation reference signal sequence, detecting the system information on a set of physical resource blocks defining a first frequency band that excludes the first set of punctured physical resource blocks; and if the demodulation reference signal sequence is detected as the second demodulation reference signal sequence, detecting the system information on a set of physical resource blocks defining a second frequency band that excludes the second set of punctured physical resource blocks.

### LIST OF DRAWINGS

Embodiments are described below, by way of example only, with reference to the accompanying drawings, in which

FIG. 1 illustrates a wireless communication scenario to which some embodiments of the invention may be applied;

FIG. 2 illustrates a structure of a system information block and its positioning providing a background for puncturing;

FIGS. 3 and 4 illustrate some embodiments of a flow diagram for communicating a system information block on a punctured frequency band;

FIGS. 5 and 6 illustrate some embodiments of signalling diagrams for communicating the system information block on a punctured frequency band; and

FIGS. 7 and 8 illustrate block diagrams of structures of apparatuses according to some embodiments.

### DESCRIPTION OF EMBODIMENTS

The following embodiments are examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

In the following, different exemplifying embodiments will be described using, as an example of an access architecture to which the embodiments may be applied, a radio access architecture based on long term evolution advanced (LTE Advanced, LTE-A) or new radio (NR, 5G), without restricting the embodiments to such an architecture, however. A person skilled in the art will realize that the embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

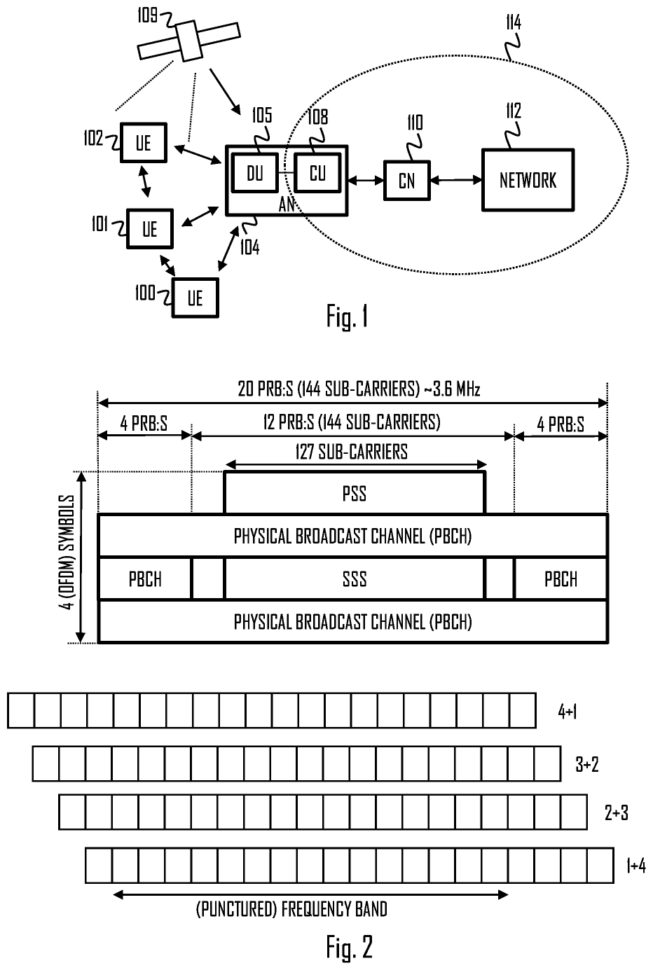

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

The example of FIG. 1 shows a part of an exemplifying radio access network.

FIG. 1 shows terminal devices or user devices 100, 101 and 102 configured to be in a wireless connection on one or more communication channels in a cell with an access node (such as (e/g) NodeB) 104 providing the cell. (e/g) NodeB refers to an eNodeB or a gNodeB, as defined in 3GPP specifications. The physical link from a user device to a (e/g) NodeB is called uplink or reverse link and the physical link from the (e/g) NodeB to the user device is called downlink or forward link. It should be appreciated that (e/g) NodeBs or their functionalities may be implemented by using any node, host, server or access point etc. entity suitable for such a usage.

A communications system typically comprises more than one (e/g) NodeB in which case the (e/g) NodeBs may also be configured to communicate with one another over links, wired or wireless, designed for the purpose. These links may be used not only for signalling purposes but also for routing data from one (e/g) NodeB to another. The (e/g) NodeB is a computing device configured to control the radio resources of communication system it is coupled to. The NodeB may also be referred to as a base station, an access point, an access node, or any other type of interfacing device including a relay station capable of operating in a wireless environment. The (e/g) NodeB includes or is coupled to transceivers. From the transceivers of the (e/g) NodeB, a connection is provided to an antenna unit that establishes bi-directional radio links to user devices. The antenna unit may comprise a plurality of antennas or antenna elements. The (e/g) NodeB is further connected to core network 110 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc.

The user device (also called UE, user equipment, user terminal, terminal device, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station. 5G specifications define two relay modes: out-of-band relay where same or different carriers may be defined for an access link and a backhaul link; and in-band-relay where the same carrier frequency or radio resources are used for both access and backhaul links. In-band relay may be seen as a baseline relay scenario. A relay node is called an integrated access and backhaul (IAB) node. It has also inbuilt support for multiple relay hops. IAB operation assumes a so-called split architecture having CU and a number of DUs. An IAB node contains two separate functionalities: DU (Distributed Unit) part of the IAB node facilitates the gNB (access node) functionalities in a relay cell, i.e. it serves as the access link; and a mobile termination (MT) part of the IAB node that facilitates the backhaul connection. A Donor node (DU part) communicates with the MT part of the IAB node, and it has a wired connection to the CU which again has a connection to the core network. In the multihop scenario, MT part (a child IAB node) communicates with a DU part of the parent IAB node.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction. The user device may also utilize cloud. In some applications, a user device may comprise a small portable device with radio parts (such as a watch, earphones or eyeglasses) and the computation is carried out in the cloud. The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, namely below 6 GHz, cmWave and mmWave, and also being capable of being integrated with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHz-cmWave-mmWave-sub-THz). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and typically fully centralized in the core network. The low-latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks 112, such as a public switched telephone network or the Internet, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU 105) and non-real time functions being carried out in a centralized manner (in a centralized unit, CU 108).

It should also be understood that the distribution of functions between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or node B (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway, maritime, and/or aeronautical communications. Satellite communication may utilize geostationary earth orbit (GEO) satellite systems, but also low earth orbit (LEO) satellite systems, in particular mega-constellations (systems in which hundreds of (nano) satellites are deployed). Each satellite 109 in the mega-constellation may cover several satellite-enabled network entities that create on-ground cells. The on-ground cells may be created through an on-ground relay node or by a gNB located on-ground or in a satellite.

It is obvious for a person skilled in the art that the depicted system is only an example of a part of a radio access system and in practice, the system may comprise a plurality of (e/g) NodeBs, the user device may have an access to a plurality of radio cells and the system may comprise also other apparatuses, such as physical layer relay nodes or other network elements, etc. At least one of the (e/g) NodeBs or may be a Home (e/g) nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g) NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g) NodeBs are required to provide such a network structure.

FIG. 2 illustrates a synchronization signal block (SSB) broadcasted by access nodes. In the embodiments described below, a system information block is used as a term for which the SSB may be one embodiment. However, the described embodiments may be applied to other system information blocks or to transmission of system information in general. In this example, the SSB complies with 3GPP specifications for the 5G NR. As defined the specifications, the SSB packs synchronization signals and a physical broadcast channel (PBCH) into one block. The synchronization signals include a primary synchronization signal (PSS) and a secondary synchronization signal (SSS) that are located at the centre of the SSB in a frequency domain. The PSS may be the sole signal transmitted on a given (orthogonal frequency division multiplexing, OFDM) symbol and, in the following symbols, the PBCH components and the SSS are transmitted as illustrated in FIG. 2. As known in the art, the PBCH carries system information (PBCH data) and a demodulation reference signal (DMRS). The PBCH data may carry, for example, a master information block defining parameters for terminal devices to detect a physical downlink control channel, e.g. parameters of a control resource set (CORESET) of the transmitting access node. LTE provides a similar SSB but with a slightly different structure.

In the example of FIG. 2, the bandwidth of the SSB is 20 physical resource blocks (PRB), each PRB having 12 sub-carriers. The bandwidth of the SSB may be 3.6 MHz when a sub-carrier spacing is 15 kHz. Now, considering the scenario described in Background where a terminal device would support a smaller bandwidth, e.g. only 3 MHz bandwidth, the SSB shall be punctured. This would mandate puncturing five PRBs from the frequency band of the SSB in the example of the previous sentence. In order to do this with minor modifications to the SSB structure, the PRBs would be punctured from the ends of the frequency band. However, in order to realize the puncturing without modifying the synchronization signals, at most four PRBs would be punctured from each end. Possible puncturing patterns would then be 4+1 (four punctured PRBs from one end and one punctured PRB from the other end of the frequency band), 3+2, 2+3, and 1+4. Most embodiments described below are related to the scenario where the number of punctured PRBs is five. The number of punctured PRBs may be different for the other scenarios and for different SSB structures, different numerologies, and for other bandwidths of the SSB and the frequency band available for transmitting the SSB.

It has been shown that the reception performance of the terminal device could be improved, e.g. in terms of signal-to-noise ratio (SNR) in symbol detection, if the terminal device knew the exact puncturing pattern used by the access node and focus its receiver to those PRBs that actually carry the SSB, excluding the punctured PRBs from reception (e.g. the PBCH detection). The benefit would increase together with the number of punctured PRBs. However, it may not be possible for the access node to use a fixed puncturing pattern. The reason is that the available bandwidth may differ and flexibility to adapt to different bandwidths may be required. As a consequence, the number of punctured PRBs may vary. Even if the number of punctured PRBs would be static, the number of PRBs punctured from each end of the SSB may vary, for example from one channel deployment to another, from one cell to another, and/or in time (e.g. as the number of carriers changes, and there is more/less PRBs available for the access node). The reason is illustrated in the bottom half of FIG. 2. Let us assume that the access node has exactly the 3 MHz frequency band available for transmitting the SSB of FIG. 2 and, accordingly, five PRBs shall be punctured. As known from the 5G NR specifications, for example, the system may support a certain grid of channel and synchronization rasters. In the 5G NR in a frequency range 1 (FR1), the channel raster is 100 kHz while the synchronization raster is more sparse in frequency domain, e.g. cluster of three synchronization raster points with 100 kHz distance from each other and 1.2 MHz separation between clusters. That means that one radio frequency (RF) channel may have one or multiple synchronization raster point(s) that may be located on the certain RF channel anywhere in the frequency domain. This is different e.g. to the LTE system where a synchronization raster point is always in the middle of the RF channel and, thus, both channel and synchronization raster points may be the same, e.g. 100 kHz. The synchronization raster indicates frequency positions of the synchronization block (PSS) that can be used by the terminal device for acquiring the system information acquisition when explicit signaling of the synchronization block position is not present. The synchronization raster point thus defines a centre frequency of the frequency band for transmitting some system information, e.g. the centre frequency of the SSB. Now, depending on which synchronization raster point is selected, the 20 PRBs of the SSB may be located with respect to the available frequency band in (e.g. four) different ways, as constrained by the channel raster. FIG. 2 on the bottom four options for covering the same frequency band by selecting different synchronization raster points. And as illustrated, each different positioning of the SSB causes a need for a different puncturing pattern. Punctured PRBs are illustrated in FIG. 2 by a dotted pattern. Therefore, it may not be possible for the access node to use a fixed puncturing and, as a consequence, the used puncturing pattern may need to be signalled to the terminal device. In order to not increase signalling overhead, an efficient solution for signalling the used puncturing pattern would be beneficial. A similar situation may be present in current and future systems other than the 5G NR and for system information other than that carried by the PBCH, so the embodiments described below shall be understood to be applicable to the signal structures other than that illustrated in FIG. 2.

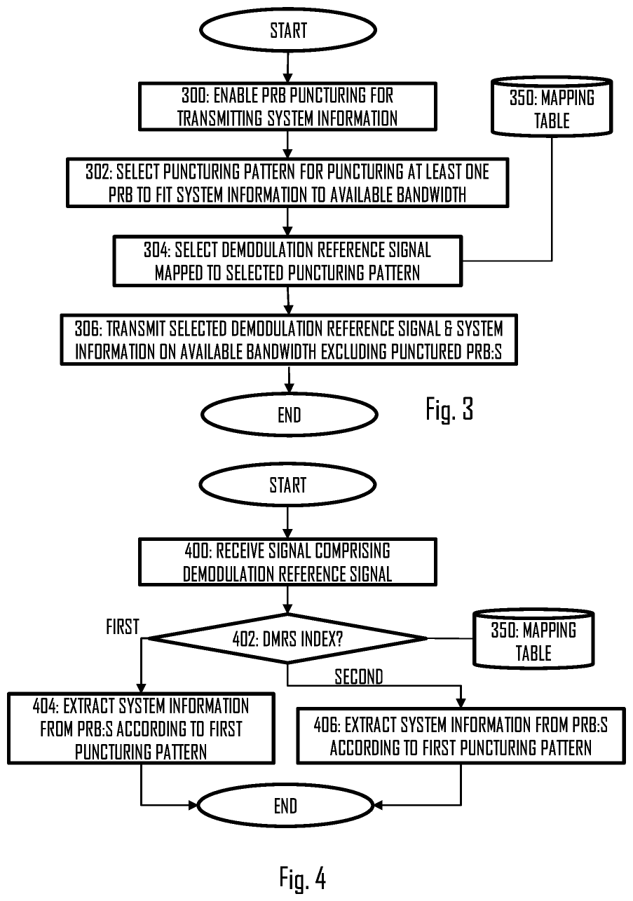

FIGS. 3 and 4 illustrate embodiments of processes for transmitting and receiving system information on a punctured frequency band. FIG. 3 illustrates a process executed by an apparatus for the access node 104 while FIG. 4 illustrates a process executed by an apparatus for the terminal device 100, 101, or 102.

Referring to FIG. 3, the process for the access node 104 comprises: storing a mapping table (350) comprising mapping information on demodulation reference signal sequences to puncturing patterns; determining (block 300), based on available bandwidth, that puncturing shall be applied to transmission of a system information block in order to fit the system information block to a frequency band having the available bandwidth; selecting (block 302), from the puncturing patterns, a first puncturing pattern to puncture at least one physical resource block to provide the available bandwidth for transmitting the system information block; selecting (block 304), on the basis of the mapping table 350, a first demodulation reference signal sequence mapped to the selected first puncturing pattern in the mapping table; and transmitting (block 306) the system information block and the first demodulation reference signal sequence by using the available bandwidth.

Referring to FIG. 4, the process for the terminal device comprises: storing a mapping table 350 comprising mapping information on demodulation reference signal sequences to puncturing patterns, the mapping information mapping a first demodulation reference signal sequence to a first puncturing pattern indicating a first set of punctured physical resource blocks, and at least a second demodulation reference signal sequence to a second puncturing pattern indicating a second set of punctured physical resource blocks; receiving (block 400) a signal comprising a demodulation reference signal sequence and system information and detecting the demodulation reference signal sequence; if the demodulation reference signal sequence is detected as the first demodulation reference signal sequence in block 402, detecting (block 404) the system information on a set of physical resource blocks defining a first frequency band that excludes the first set of punctured physical resource blocks; and if the demodulation reference signal sequence is detected as the second demodulation reference signal sequence in block 402, detecting (block 406) the system information on a set of physical resource blocks defining a second frequency band that excludes the second set of punctured physical resource blocks. An advantage is that the access node can flexibly adapt the transmission band carrying the system information to a bandwidth that is narrower than a default bandwidth (e.g. 20 PRBs forming the 3.6 MHz bandwidth described above) for transmitting the system information (block). Furthermore, the terminal device is able to unambiguously determine the puncturing pattern used for the transmission of the system info before conducting decoding of the system information, and can then perform demodulation and decoding of the system information with better performance (better SNR) by excluding the punctured PRBs in the demodulation, detection, and decoding.

In an embodiment, the puncturing is enabled only to certain operational conditions. Accordingly, the access node may enable or disable the puncturing, depending on prevailing operational conditions. For example, the puncturing may be applied to a certain frequency range and/or to certain frequency bands, e.g. frequency band(s) of the GSM-R or Future Railway Mobile Communication System (FRMCS). This band may be called n100. Additionally, or alternatively, the puncturing may be enabled for certain one or more numerologies (sub-carrier spacings), e.g. to 15 kHz sub-carrier spacing.

Since the frequency band for transmitting the system information is, after the puncturing, smaller than the default bandwidth or, equivalently, the number of PRBs for transmitting the system information is smaller, the number of symbols carrying the system information may also be smaller. This may be handled by adapting a modulation and coding scheme to the available bandwidth such that the same system information may still be sent as with the default bandwidth. One option would be to use the same modulation and coding scheme and sub-carrier allocation with the punctured and default frequency band, and to puncture system information symbols or bits allocated to the punctured PRBs. The modulation and coding scheme is transmitted with very high reliability and sufficient reliability may be maintained even after puncturing some system information symbols allocated to the puncture PRBs. An advantage would be that the modulation and coding scheme may be maintained for all puncturing patterns, including a puncturing pattern indicated puncturing of zero PRBs. Another method for adapting a coding rate of the system information to the narrower bandwidth may be equally utilized, e.g. maintaining the same modulation and coding scheme as for the default bandwidth but omitting allocation of coded and modulated symbols to the punctured PRBs and, as in the other embodiments, omitting transmission of any signal on the punctured PRBs. In summary, the access node may transmit a signal carrying the system information without any modulation symbols or reference signals on the punctured PRBs.

As described above in connection with FIG. 2, the punctured PRBs may be on one or both sides of the PRBs carrying the synchronization signal (PSS and/or SSS). Accordingly, all the puncturing patterns may define puncturing of PRBs such that the PRBs carrying the synchronization signal(s) shall not be punctured. Accordingly, synchronization performance of the terminal device may be maintained even after the puncturing and the terminal device is able to use existing (legacy) implementations for synchronization signal detection, synchronization acquisition and tracking.

Let us then disclose some embodiments of the mapping table providing mappings between the puncturing patterns and the DMRS sequence indices. According to the current 5G NR specifications, the DMRS is currently used to signal a SSB index and a half-frame. The SSB index refers to that, in case the access node 104 uses multiple beams to transmit the SSB, each beam has a unique SSB index. The use of multiple beams may derive from that the access node cannot cover the whole coverage area of a cell efficiently with one beam. The beams may have different beamforming configurations, e.g. different spatial patterns in terms of beam width, beam angle, and beam strength (proportional to beam coverage area). The half-frame indicates whether the SSB is transmitted in a first or second half-frame of a radio frame, e.g. a 5G NR frame. The length of the radio frame may be 10 ms and the length of the half-frame may be 5 ms, for example. In the embodiments described below, the DMRS is mapped to a puncturing pattern in the mapping table. In embodiments where the DMRS further indicates the SSB index and/or half-frame, the mapping table maps each demodulation reference signal sequence of the mapping table to a unique combination of the puncturing pattern and one or both of the half-frame index and a SSB index. Yet another parameter that may be indicated via the DMRS is a channel bandwidth. The channel bandwidth (CBW) may directly map to the puncturing pattern. For example, one DMRS index may be mapped to a puncturing pattern that indicates that no puncturing shall be applied. This may implicitly indicate a broader bandwidth, e.g. a 5 MHz bandwidth. Additionally, another DMRS index may be mapped to a puncturing pattern indicating that at least one PRB shall be punctured, thus implicitly indicating a smaller bandwidth, e.g. a 3 MHz bandwidth.

In the current specifications for 5G, the access node has eight different DMRS sequences available. It should be appreciated that this limitation does not limit the present invention, and the number of different DMRS sequences available may be different in other embodiments. The mapping tables in the embodiments below are designed so that no additional DMRS sequences are needed to indicate the puncturing pattern. Accordingly, the embodiments below thus provide for an efficient way to indicate more information by using the same number of DMRS sequences.

Table 1 below illustrates an embodiment where the half-frame indication is reduced by configuring the access node to transmit the system information (SSB) always in the first half-frame. This gives room to indicate two different puncturing patterns with the same number of DMRS sequences.

TABLE 1

| | | Punturing | | |
|---|---|---|---|---|
| DMRS index | SSB index | pattern (CBW) | | Half-frame |
| 0 | 0 | No/5 | MHz | 1 |
| 1 | 1 | No/5 | MHz | 1 |
| 2 | 2 | No/5 | MHz | 1 |
| 3 | 3 | No/5 | MHz | 1 |
| 4 | 0 | 2 + 3/3 | MHz | 1 |
| 5 | 1 | 2 + 3/3 | MHz | 1 |
| 6 | 2 | 2 + 3/3 | MHz | 1 |
| 7 | 3 | 2 + 3/3 | MHz | 1 |

Upon determining to use the puncturing, the access node may then select one of the DMRS sequences 4 to 7, depending on the beam where the system information is transmitted. Accordingly, each different beam will have a unique DMRS index 4 to 7. Upon determining that no puncturing shall be used, the access node may select one of the DMRS sequences 0 to 3, depending on the beam where the system information is transmitted. Accordingly, each different beam will have a unique DMRS index 0 to 3. Upon detecting the PSS or SSS and the DMRS from a received signal, the terminal device is able to use the mapping table to map the DMRS index of the detected DMRS to the SSB index and the puncturing pattern. The DMRS detection may be realized by correlating, after synchronizing to the PSS or SSS, the received signal with known DMRS sequences, as known in the art. The SSB index (and the half-frame) may be used for gaining timing information, e.g. to compute frame or time slot boundaries, as known in the art. The puncturing pattern may be used to exclude punctured PRBs from the demodulation and detection of the system information, as described above, to improve the detection performance. As described above, the puncturing pattern ‘2+3’ means that two PRBs are punctured from one end of the frequency band and three PRBs are punctured from the other end of the frequency band. ‘No’ means no puncturing of PRBs. The same logics apply to the other embodiments below.

In an embodiment, the puncturing pattern indicating no puncturing of PRBs may cause the terminal device to receive and detect all PRBs of the SSB. The access node may always transmit a first subset of the PRBs (e.g. PRBs #0 to #17) and optionally transmit a second subset of the PRBs (e.g. PRBs #18 and #19). Since the terminal device assumes no puncturing, it is able to receive all the relevant information in both cases: where the access node transmits all PRBs and where the access node transmits only the first subset of PRBs.

In the embodiment of FIG. 2, the number of punctured PRBs is the same for all puncturing patterns. This need not to be mandatory, and the mapping table may provide two (or more) puncturing patterns that both puncture at least one PRB but different numbers of PRBs. Table 2 below provides such an embodiment.

TABLE 2

| | | Punturing | | |
|---|---|---|---|---|
| DMRS index | SSB index | pattern (CBW) | | Half-frame |
| 0 | 0 | 0 + 2/5 | MHz | 1 |
| 1 | 1 | 0 + 2/5 | MHz | 1 |
| 2 | 2 | 0 + 2/5 | MHz | 1 |
| 3 | 3 | 0 + 2/5 | MHz | 1 |
| 4 | 0 | 2 + 3/3 | MHz | 1 |
| 5 | 1 | 2 + 3/3 | MHz | 1 |
| 6 | 2 | 2 + 3/3 | MHz | 1 |
| 7 | 3 | 2 + 3/3 | MHz | 1 |

Table 3 below illustrates an embodiment is similar to that of Tables 1 and 2 in the sense that the half-frame indication is reduced by configuring the access node to transmit the system information (SSB) always in the first half-frame. Furthermore, the access node is now limited to transmit the SSB in a reduced set of beams (four in the embodiment of Table 1, two in the embodiment of Table 3). This gives more room to indicate further puncturing patterns with the same number of DMRS sequences.

TABLE 3

| | | Punturing | | |
|---|---|---|---|---|
| DMRS index | SSB index | pattern (CBW) | | Half-frame |
| 0 | 0 | No/5 | MHz | 1 |
| 1 | 1 | No/5 | MHz | 1 |
| 2 | 0 | 3 + 2/3 | MHz | 1 |
| 3 | 1 | 3 + 2/3 | MHz | 1 |
| 4 | 0 | 2 + 3/3 | MHz | 1 |
| 5 | 1 | 2 + 3/3 | MHz | 1 |
| 6 | 0 | 4 + 1/3 | MHz | 1 |
| 7 | 1 | 4 + 1/3 | MHz | 1 |

In this embodiment, four different puncturing patterns can be signalled by using eight different DMRS sequences. Some puncturing patterns that indicating puncturing of at least one PRB define the same number of punctured PRBs but with different patterns (3+2, 2+3, 4+1).

In an embodiment similar to Table 1, the puncturing pattern indicating no puncturing of PRBs in Table 3 may cause the terminal device to receive and detect all PRBs of the SSB. The access node may always transmit a first subset of the PRBs (e.g. PRBs #0 to #17) and optionally transmit a second subset of the PRBs (e.g. PRBs #18 and #19). Since the terminal device assumes no puncturing, it is able to receive all the relevant information in both cases: where the access node transmits all PRBs and where the access node transmits only the first subset of PRBs.

In a variant of Table 3, the mapping table may provide two (or more) puncturing patterns that both indicate puncturing of at least one PRB but different numbers of PRBs. Table 4 below provides such an embodiment.

TABLE 4

| | | Punturing | | |
|---|---|---|---|---|
| DMRS index | SSB index | pattern (CBW) | | Half-frame |
| 0 | 0 | 0 + 2/5 | MHz | 1 |
| 1 | 1 | 0 + 2/5 | MHz | 1 |
| 2 | 0 | 3 + 2/3 | MHz | 1 |
| 3 | 1 | 3 + 2/3 | MHz | 1 |
| 4 | 0 | 2 + 3/3 | MHz | 1 |
| 5 | 1 | 2 + 3/3 | MHz | 1 |
| 6 | 0 | 4 + 1/3 | MHz | 1 |
| 7 | 1 | 4 + 1/3 | MHz | 1 |

Table 5 below illustrates an embodiment where the access node is allowed to use either half-frame to transmit the system information but the number of beams to transmit the system information is reduced, thus making room for signalling the puncturing pattern.

TABLE 5

| | | Punturing | | |
|---|---|---|---|---|
| DMRS index | SSB index | pattern (CBW) | | Half-frame |
| 0 | 0 | No/5 | MHz | 1 |
| 1 | 1 | No/5 | MHz | 1 |
| 2 | 0 | 3 + 2/3 | MHz | 1 |
| 3 | 1 | 3 + 2/3 | MHz | 1 |
| 4 | 0 | No/5 | MHz | 2 |
| 5 | 1 | No/5 | MHz | 2 |
| 6 | 0 | 3 + 2/3 | MHz | 2 |
| 7 | 1 | 3 + 2/3 | MHz | 2 |

The logic is the same as above, upon determining to transmit the system information in the first half-frame, the access node has DMRS indices 0 to 3 available, while upon determining to transmit the system information in the second (latter) half-frame, the access node has DMRS indices 4 to 7 available. Two alternative puncturing patterns are defined for all combinations of the SSB index and half-frame index: no puncturing and 3+2 puncturing.

In an embodiment similar to Tables 1 and 3, the puncturing pattern indicating no puncturing of PRBs in Table 5 may cause the terminal device to receive and detect all PRBs of the SSB. The access node may always transmit a first subset of the PRBs (e.g. PRBs #0 to #16) and optionally transmit a second subset of the PRBs (e.g. PRBs #17 and #19). Since the terminal device assumes no puncturing, it is able to receive all the relevant information in both cases: where the access node transmits all PRBs and where the access node transmits only the first subset of PRBs.

In a variant of Table 5, the mapping table may provide two (or more) puncturing patterns that both indicate puncturing of at least one PRB but different numbers of PRBs. The number of punctured PRBs is exemplary. Table 6 below provides such an embodiment.

TABLE 6

| | | Punturing | | |
|---|---|---|---|---|
| DMRS index | SSB index | pattern (CBW) | | Half-frame |
| 0 | 0 | 2 + 0/5 | MHz | 1 |
| 1 | 1 | 2 + 0/5 | MHz | 1 |
| 2 | 0 | 3 + 2/3 | MHz | 1 |
| 3 | 1 | 3 + 2/3 | MHz | 1 |
| 4 | 0 | 2 + 0/5 | MHZ | 2 |
| 5 | 1 | 2 + 0/5 | MHZ | 2 |
| 6 | 0 | 3 + 2/3 | MHz | 2 |
| 7 | 1 | 3 + 2/3 | MHz | 2 |

Table 7 below illustrates an embodiment where the access node is allowed to use either half-frame to transmit the system information but the number of beams to transmit the system information is further reduced, thus making more room for signalling the puncturing pattern.

TABLE 7

| | | Punturing | | |
|---|---|---|---|---|
| DMRS index | SSB index | pattern (CBW) | | Half-frame |
| 0 | 0 | No/5 | MHz | 1 |
| 1 | 0 | 3 + 2/3 | MHz | 1 |
| 2 | 0 | 2 + 3/3 | MHz | 1 |
| 3 | 0 | 4 + 1/3 | MHz | 1 |
| 4 | 0 | No/5 | MHz | 2 |
| 5 | 0 | 3 + 2/3 | MHz | 2 |
| 6 | 0 | 2 + 3/3 | MHz | 2 |
| 7 | 0 | 4 + 1/3 | MHz | 2 |

In the embodiment of Table 7, the access node covers the whole cell with a single beam, thus allowing the use of only one SSB index and the use of more options for the different puncturing patterns.

In an embodiment similar to Tables 1, 3, and 5, the puncturing pattern indicating no puncturing of PRBs in Table 7 may cause the terminal device to receive and detect all PRBs of the SSB. The access node may always transmit a first subset of the PRBs (e.g. PRBs #0 to #18) and optionally transmit a second subset of the PRBs (e.g. PRB #19). Since the terminal device assumes no puncturing, it is able to receive all the relevant information in both cases: where the access node transmits all PRBs and where the access node transmits only the first subset of PRBs.

In a variant of Table 7, the mapping table may provide two (or more) puncturing patterns that both indicate puncturing of at least one PRB but different numbers of PRBs. The number of punctured PRBs is exemplary. Table 8 below provides such an embodiment

TABLE 8

| | | Punturing | | |
|---|---|---|---|---|
| DMRS index | SSB index | pattern (CBW) | | Half-frame |
| 0 | 0 | 0 + 2/5 | MHz | 1 |
| 1 | 0 | 3 + 2/3 | MHz | 1 |
| 2 | 0 | 2 + 3/3 | MHz | 1 |
| 3 | 0 | 4 + 1/3 | MHz | 1 |
| 4 | 0 | 0 + 2/5 | MHz | 2 |
| 5 | 0 | 3 + 2/3 | MHz | 2 |
| 6 | 0 | 2 + 3/3 | MHz | 2 |
| 7 | 0 | 4 + 1/3 | MHz | 2 |

Tables 9 and 10 below then relate to embodiments where the number of beams used to transmit the system information is smaller than the number of different SSB indices in the mapping table. Accordingly, the state-of-the-art logic for mapping the DMRS only to the SSB index and the half-frame index may be maintained, but the mapping table 350 may provide an additional mapping between the SSB index and the puncturing pattern. In the big picture, the mapping is still between the DMRS and the puncturing pattern but these embodiments require no modification of the existing logic between the DMRS and the SSB index. In an embodiment, the number of different SSB indices is a multiple greater than one of a number of different transmission beams where the access node is able to transmit the SSB.

Table 9 below provides an embodiment of the mapping table 350 in a scenario where the maximum number of beams carrying the system information is two, and the number SSB indices is four, thus allowing the SSB index to signal two different puncturing patterns

TABLE 9

| SSB index | Puncturing pattern (CBW) | |
|---|---|---|
| 0 | No/5 | MHz |
| 1 | No/5 | MHz |
| 2 | 3 + 2/3 | MHz |
| 3 | 3 + 2/3 | MHz |

In other words, the number of different beams transmitting the system information is two but the system information can be transmitted at four different ‘locations’, thus the location of the system information indicating also the puncturing pattern. The logic for selecting the DMRS for the access node is then that the access node may first determine whether or not the puncturing is needed. On the basis of that, the access node has available either SSB indices 0 and 1 or 2 and 3. Then, the access node may select the DMRS sequences mapped to the available SSB indices so that a first beam carrying the system information uses one of the selected DMRS sequences, and a second beam carrying the system information uses the other one of the selected DMRS sequences. From the perspective of the terminal device, the terminal device first detects the DMRS sequence from the received signal (SSB), then maps the DMRS to the SSB index, and then maps the selected SSB index to the puncturing pattern and proceeds to demodulate and detect the system information from the non-punctured PRBs in the above-described manner.

Table 10 below illustrates an embodiment where the access node uses only a single beam to transmit the system information but has multiple (four in this example) different SSB indices available. In such a case, the SSB index becomes an explicit puncturing pattern indicator where each SSB index is mapped to a different puncturing pattern.

TABLE 10

| SSB index | Puncturing pattern (CBW) | |
|---|---|---|
| 0 | No/5 | MHz |
| 1 | 3 + 2/3 | MHz |
| 2 | 2 + 3/3 | MHz |
| 3 | 4 + 1/3 | MHz |

In summary, some puncturing patterns of the mapping table may indicate the same puncturing pattern, thus allowing for the access node to add other signalling information to the DMRS, e.g. the SSB index or the half-frame index. In another embodiment, only the puncturing pattern is signalled by the selection of the DMRS.

The system information and the DMRS may be transmitted on a physical broadcast channel (PBCH) on the frequency band subjected to puncturing of PRBs, in case the puncturing is used. The punctured frequency band may originate from a 3.6 MHz frequency band that is reduced to a bandwidth of 3 MHz by puncturing the PRBs according to a given puncturing pattern. In situations where the broader bandwidth can be transmitted, the system information (PBCH) may be transmitted with the original bandwidth.

As provided in the embodiments above, one of the SSB index and the half-frame index is the same for all DMRS sequences of the mapping table and the other one of the SSB index and the half-frame index varies between DMRS sequences of the mapping table.

In some embodiments, e.g. Tables 1, 2, 5, 6, and 9, the mapping table maps two different puncturing patterns, including no puncturing. Even in such a case, the mapping table may define at least one puncturing pattern that indicates puncturing of at least one PRB. In other embodiments such as the Tables 3, 4, 7, 8, and 10, the mapping table maps four different puncturing patterns, including no puncturing. As a consequence, each of the other three puncturing patterns indicates puncturing of at least one PRB. In other embodiments, the mapping table maps another number of different puncturing patterns. It may be summarized that the mapping table may map at least two or at least four different puncturing patterns, including at least one puncturing pattern that indicates puncturing of at least one PRB. The total number of different DMRS sequences may be eight, for example.

The puncturing described above may apply to the DMRS as well. Without the puncturing, a full DMRS sequence would be transmitted on the default frequency band but, as a result of the puncturing, at least some symbols of the DMRS sequence may be punctured as well. Since the minority of the DMRS symbols becomes punctured, a sufficient number of DMRS symbols may remain in order to carry out reliable detection of the DMRS sequence. Since the puncturing pattern is not known at the time of detecting the DMRS, the DMRS detection may be carried out on the broader frequency band than the frequency band used in the following detection of the system information where the punctured PRBs have been excluded.

As described above, the embodiments of Tables 1 to 10 are exemplary, and it is possible to modify the embodiments by replacing of an entry of one mapping table from another mapping table, or by creating a new mapping table with a different arrangement of the puncturing patterns and their mapping to the different DMRS sequences.

The terminal device may carry out the detection of the DMRS sequence (only) on PRBs used for synchronisation signals (see the 12 PRBs carrying the PSS and SSS in FIG. 2). Thereafter, channel estimation based on the DMRS may be carried for a broader frequency band (more PRBs) used also in the following detection and decoding of the system information (e.g. the PRBs that exclude the punctured PRBs). As described above, the SSB index may be used by the terminal device for determining frame or slot timing. In the embodiments of Tables 9 and 10, there may be a smaller number of SSB index values than a number of possible SSB locations in time allow indication of the puncturing pattern via the location of the SSB. However, the mapping may still logically be between the DMRS and the puncturing pattern. Therefore, Tables 9 and 10 may be understood as simplifications. Table 11 below provides a different illustration and mapping between the DMRS index and the puncturing pattern. Further, Table 11 defines eight SSB positions (by the parameter Candidate SSB Index) but only two SSB beams for the cell (by the parameter SSB Index). In the embodiment of Table 11, the terminal device determines the slot timing within a half-frame based on the “candidate” SSB index parameter according to Table 11. The relation between the value of the Candidate SSB Index and the SSB index may be defined via a modulo operation: SSB index=mod (candidate SSB index, number of SSB indices in the cell). The terminal device may thus determine the slot timing by employing this relation.

TABLE 11

| | Candidate | | Punturing | | |
|---|---|---|---|---|---|
| DMRS index | SSB index | SSB index | pattern (CBW) | | Half-frame |
| 0 | 0 | 0 | 2 + 0/5 | MHz | 1 |
| 1 | 1 | 1 | 2 + 0/5 | MHz | 1 |
| 2 | 2 | 0 | 3 + 2/3 | MHz | 1 |
| 3 | 3 | 1 | 3 + 2/3 | MHz | 1 |
| 4 | 4 | 0 | 2 + 0/5 | MHZ | 2 |
| 5 | 5 | 1 | 2 + 0/5 | MHZ | 2 |
| 6 | 6 | 0 | 3 + 2/3 | MHz | 2 |
| 7 | 7 | 1 | 3 + 2/3 | MHz | 2 |

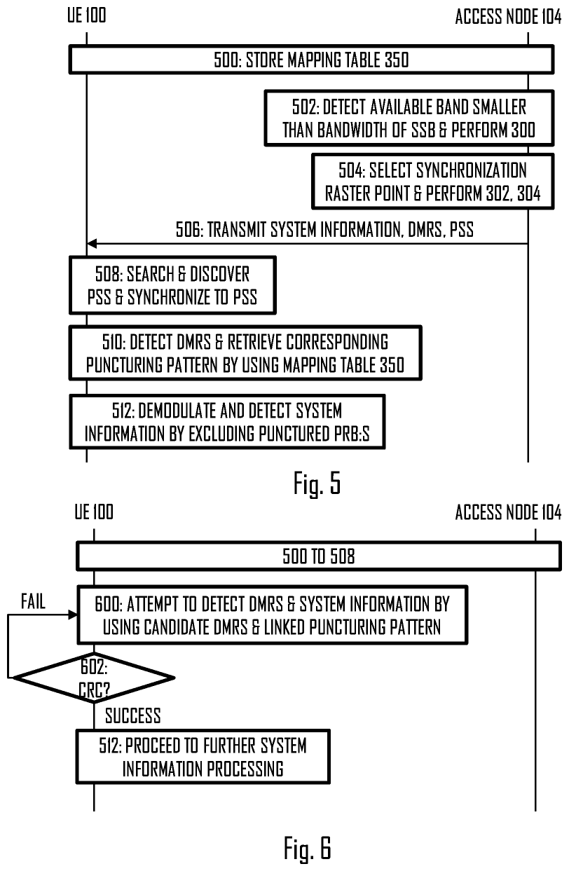

FIGS. 5 and 6 illustrate signalling diagrams of embodiments for transmission and reception of the system information by using the puncturing and signalling the puncturing pattern. The difference between FIGS. 5 and 6 is in how the terminal device detects the puncturing pattern. Referring to FIG. 5, the terminal device (UE) 100 and the access node 104 store the mapping table 350 in step 500. The mapping table 350 may be a fixed parameter part of a permanent system configuration. Accordingly, the mapping table may be stored in both the terminal device and the access node in a static manner. Alternatively, the mapping table is dynamic, e.g. the mapping table may incorporate the mapping to the puncturing pattern only under the specific conditions, as described above. Even in such a case, the mapping table may be static for such specific conditions. However, in case more flexibility is needed, the access node may generate or modify the mapping table and signal the prevailing mapping table to the terminal device. Since the mapping table is used for acquiring the system information, the signalling of the mapping table may be carried out at a convenient occasion, e.g. before guiding the terminal device to a system band that uses the puncturing patterns of the mapping table. For example, the terminal device may carry out initial access to the access node on a system band not employing the puncturing patterns and, as a consequence, receive the mapping table form the access node. Upon switching to a frequency band using the puncturing described herein, the terminal device may then take the mapping table into use. In another embodiment, the access node updates or re-configures the mapping table and signals it to the terminal device after the terminal device has carried out the initial access and accessed the access node on the system band employing a puncturing pattern according to any one of the above-described embodiments. Upon carrying out the initial access on the same frequency band next time, the terminal device may then take the updated mapping table into use. Such a mapping table updating may be used especially when the number of punctured PRBs changes on the frequency band, e.g. decreases gradually.

Upon detecting that the available frequency band for transmitting the system information is smaller than a default bandwidth for the system information, the access node may enable the puncturing in block 502. Then, the access node may select a synchronization raster point for transmitting the system information, thus fixing the centre of the synchronization signal sequences transmitted together with the system information. Since the structure of the system information (e.g. SSB) follows this decision, the access node then knows how many PRBs to puncture from each end of the default band of the system information and selects the puncturing pattern (block 504). Upon selecting the puncturing pattern, the access node may select the DMRS mapped to the puncturing pattern and, optionally, to other parameters of the transmission signalled via the DMRS sequence. Then, the access node transmits the system information, the DMRS sequence, the PSS (and SSS) in step 506.

The terminal device attempts to detect, from a received signal, the SSB in order to gain the system information for accessing the access node, and scans for the PSS (and SSS but let us focus on the PSS for the sake of simplicity). Upon detecting the PSS in the transmission of step 506, the terminal device is able to synchronize to the PSS and the symbol timing of the transmission. Thereafter, the terminal device may carry out correlation in order to detect the DMRS in the received signal (block 510). Upon detecting the DMRS, the terminal device may access the mapping table 350 to find the puncturing pattern mapped to the detected DMRS in the mapping table. Upon determining the puncturing pattern, the terminal device may puncture the corresponding PRBs from the received signal and focus demodulation and detection of the system information (and other reception functions) on the PRBs that were transmitted by the access node (block 512), as described above. Upon detecting the system information, the terminal device may perform a cyclic redundancy check (CRC) on the detected system information. If the CRC is passed, the terminal device may proceed with extracting further system information such as a system information block 1 (SIB-1) or with other processing of the system information (block 512). For example, the system information block may carry a master information block indicating resources for a physical downlink control channel (PDCCH). Upon extracting the master information block, the terminal device is capable of finding a control resource set (CORESET) on which the access node transmits scheduling information or other control information for further system information. The further system information may then be transmitted on a physical downlink shared channel (PDSCH) in compliance with the control information. In an embodiment, the terminal device applies the same puncturing pattern to the system information block and at least one of the control information and the further system information. If the CRC fails, the terminal device may attempt to detect the same system information from a subsequent transmission of the access node. As a consequence, the terminal device may return to scan for the PSS. Upon detecting the next transmission, the terminal device may again detect the system information, combine the two instances of detected system information and perform the CRC again. In this manner, the terminal device may collate the system information until the CRC is passed.

FIG. 6 illustrates an embodiment where the terminal device performs the DMRS detection jointly with detection of the system information. The terminal device may use the mapping table to generate candidate configurations covering the different puncturing patterns of the mapping table, e.g. the eight configurations in the embodiment of Table 1 or 2. The terminal device may then attempt detection of the DMRS and the system information by using one of these candidates (block 600) and perform the CRC check on the detected symbols of a candidate. If the CRC fails in block 602, the terminal device may return to block 600 and select the next candidate. In this manner, the process may proceed until the CRC is successful or until all candidates have been tried. If the CRC is a failure for all candidates, the terminal device may scan for the subsequent transmission and collate the DMRSs and the respective system information per candidate, as described in the embodiment of FIG. 5. When the CRC is passed, block 512 may be performed.

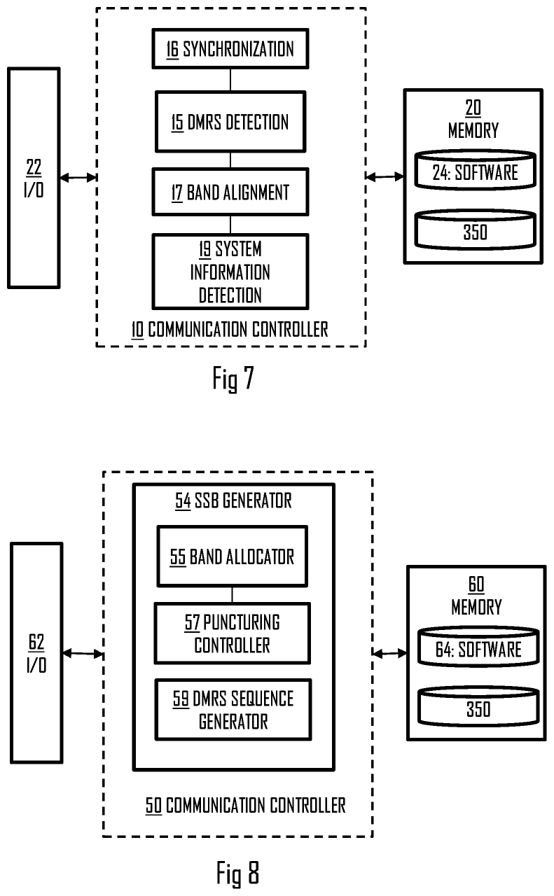

FIG. 7 illustrates an apparatus comprising means for carrying out the process of FIG. 4 or any one of the embodiments described above. The apparatus may comprise a processing circuitry, such as at least one processor, and at least one memory 20 including computer program code or computer program instructions (software) 24, wherein the at least one memory and the computer program code (software) are configured, with the at least one processor, to cause the apparatus to carry out the process of FIG. 4 or any one of its embodiments described above. The apparatus may be for the terminal device 100. The apparatus may be a circuitry or an electronic device realizing some embodiments of the invention in the terminal device 100. The apparatus carrying out the above-described functionalities may thus be comprised in such a device, e.g. the apparatus may comprise a circuitry such as a chip, a chipset, a processor, a micro controller, or a combination of such circuitries for the terminal device 100. The at least one processor or a processing circuitry may realize a communication controller 10 controlling communications in a radio interface of the cellular communication system in the above-described manner. The communication controller may be configured to establish and manage radio connections, transfer of data over radio resource control (RRC) connections with the access node 104. The communication controller may further carry out or control cell search procedures such as scanning and detection of the above-described system information.

The communication controller 10 may comprise a synchronization circuitry 16 configured to perform synchronization to the PSS and SSS. Upon acquiring the synchronization, the communication controller 10 may trigger a DMRS detection circuit 15 to perform correlation and detect the DMRS sequence (DMRS sequence index). Upon detecting the DMRS sequence index, the communication controller may access the mapping table 350 and determine the puncturing pattern mapped to the DMRS index. Thereafter, the communication controller may use a band alignment circuitry 17 to focus detection of system information (and other reception functions such as equalization) on the PRBs that have not been punctured. In other words, the PRBs indicated by the mapping table to have been punctured by the access node may be excluded by the band alignment circuitry 17. Thereafter, the remaining PRBs may be subjected to the demodulation and detection of the system information by a system information detection circuit 19.

The apparatus may further comprise an application processor (not shown) executing one or more computer program applications that generate a need to transmit and/or receive data through the communication controller 10. The application processor may form an application layer of the apparatus. The application processor may execute computer programs forming the primary function of the apparatus. For example, if the apparatus is a sensor device, the application processor may execute one or more signal processing applications processing measurement data acquired from one or more sensor heads. If the apparatus is a computer system of a vehicle, the application processor may execute a media application and/or an autonomous driving and navigation application. Positioning of the apparatus may be beneficial for all these applications. The application processor may thus generate a command for executing the process of FIG. 3.

The memory 20 may be implemented using any suitable data storage technology, such as semiconductor-based memory devices, flash memory, magnetic memory devices and systems, optical memory devices and systems, fixed memory and removable memory. The memory 20 may comprise the mapping table 350.

The apparatus may further comprise a communication interface 22 comprising hardware and/or software for providing the apparatus with radio communication capability, as described above. The communication interface 22 may include, for example, an antenna, one or more radio frequency filters, a power amplifier, and one or more frequency converters. The communication interface 22 may comprise hardware and software needed for realizing the radio communications over the radio interface, e.g. according to specifications of an LTE or 5G radio interface.

FIG. 8 illustrates an apparatus comprising a processing circuitry, such as at least one processor, and at least one memory 60 including a computer program code or computer program instructions (software) 64, wherein the at least one memory and the computer program code or computer program instructions are configured, with the at least one processor, to cause the apparatus to carry out functions of the access node in the process of FIG. 3 or any one of its embodiments described above. The apparatus may be for the access node 104. The apparatus may be a circuitry or an electronic device realizing some of the above-described embodiments in the access node. The apparatus carrying out the above-described functionalities may thus be comprised in such a device, e.g. the apparatus may comprise a circuitry such as a chip, a chipset, a processor, a micro controller, or a combination of such circuitries for the access node. In other embodiments, the apparatus is the access node. The at least one processor or a processing circuitry may realize a communication controller 50 controlling communications in the above-described manner. The communication controller may be configured to establish and manage radio connections and transfer of data over the radio connections, including radio resource control (RRC) connections. The communication controller may also control transmission of system information according to the embodiments described above.

The communication controller 50 may further comprise a SSB generator circuit 54 or an equivalent circuit configured to generate a transmission block comprising the system information and the DMRS (and the synchronization signal(s)). The SSB generator circuit 54 may comprise a band allocator 55 configured to select a frequency band for transmitting the system information. The band allocator may determine whether the system information can be transmitted with a default channel bandwidth or with a lower bandwidth. If the default CBW is not available, the band allocator circuit may issue a puncturing controller 57 to select a puncturing pattern for the available frequency band. The puncturing controller 57 may determine the position of the frequency band and the arrangement of the system information block on it, e.g. on the basis of a selected synchronization raster point. Upon selecting the puncturing pattern, the puncturing controller may indicate the selected puncturing pattern to a DMRS sequence generator 59 that shall generate the DMRS sequence on the basis of the received puncturing pattern (and other information such as the SSB index and/or the half-frame index) and the mapping table 350, and proceed with the generation of the DMRS sequence for the system information block. The SSB generator 54 may then generate the system information block comprising the system information, the generated DMRS sequence, and the other relevant contents. If the default frequency band is available, the band allocator circuit may issue the DMRS sequence generator 59 to generate a DMRS sequence indicating that no puncturing has been applied, by using the mapping table 350.

The memory 60 may be implemented using any suitable data storage technology, such as semiconductor-based memory devices, flash memory, magnetic memory devices and systems, optical memory devices and systems, fixed memory and removable memory. The memory 60 may comprise the mapping table 350.

The apparatus may further comprise a radio frequency communication interface 62 comprising hardware and/or software for providing the apparatus with radio communication capability with the terminal device, as described above. The communication interface 62 may include, for example, an antenna array, one or more radio frequency filters, a power amplifier, and one or more frequency converters. The communication interface 62 may comprise hardware and software needed for realizing the radio communications over the radio interface, e.g. according to specifications of an LTE or 5G radio interface. The apparatus may further comprise a wired interface for communicating with the core network and/or with other access nodes.

As used in this application, the term ‘circuitry’ refers to one or more of the following: (a) hardware-only circuit implementations such as implementations in only analog and/or digital circuitry; (b) combinations of circuits and software and/or firmware, such as (as applicable): (i) a combination of processor(s) or processor cores; or (ii) portions of processor(s)/software including digital signal processor(s), software, and at least one memory that work together to cause an apparatus to perform specific functions; and (c) circuits, such as a microprocessor(s) or a portion of a microprocessor(s), that require software or firmware for operation, even if the software or firmware is not physically present.

This definition of ‘circuitry’ applies to uses of this term in this application. As a further example, as used in this application, the term “circuitry” would also cover an implementation of merely a processor (or multiple processors) or portion of a processor, e.g. one core of a multi-core processor, and its (or their) accompanying software and/or firmware. The term “circuitry” would also cover, for example and if applicable to the particular element, a baseband integrated circuit, an application-specific integrated circuit (ASIC), and/or a field-programmable grid array (FPGA) circuit for the apparatus according to an embodiment of the invention.

The processes or methods described in FIGS. 3 to 6, or any of the embodiments thereof may also be carried out in the form of one or more computer processes defined by one or more computer programs. The computer program(s) may be in source code form, object code form, or in some intermediate form, and it may be stored in some sort of carrier, which may be any entity or device capable of carrying the program. Such carriers include transitory and/or non-transitory computer media, e.g. a record medium, computer memory, read-only memory, electrical carrier signal, telecommunications signal, and software distribution package. Depending on the processing power needed, the computer program may be executed in a single electronic digital processing unit or it may be distributed amongst a number of processing units. References to computer-readable program code, computer program, computer instructions, computer code etc. should be understood to express software for a programmable processor such as programmable content stored in a hardware device as instructions for a processor, or as configured or configurable settings for a fixed function device, gate array, or a programmable logic device.

Embodiments described herein are applicable to wireless networks defined above but also to other wireless networks. The protocols used, the specifications of the wireless networks and their network elements develop rapidly. Such development may require extra changes to the described embodiments. Therefore, all words and expressions should be interpreted broadly and they are intended to illustrate, not to restrict, the embodiment. It will be obvious to a person skilled in the art that, as technology advances, the inventive concept can be implemented in various ways. Embodiments are not limited to the examples described above but may vary within the scope of the claims.

1-39. (canceled)

40. An apparatus comprising at least one processor and at least one memory storing instructions that cause the apparatus to: store a mapping table comprising mapping information on demodulation reference signal sequences to puncturing patterns;
determine, based on available bandwidth, that puncturing shall be applied to transmission of a system information block in order to fit the system information block to a frequency band having the available bandwidth;
select, from the puncturing patterns, a first puncturing pattern to puncture at least one physical resource block to provide the available bandwidth for transmitting the system information block;
select, on the basis of the mapping table, a first demodulation reference signal sequence mapped to the selected first puncturing pattern in the mapping table; and
transmit the system information block and the first demodulation reference signal sequence by using the available bandwidth.

41. The apparatus of claim 40, wherein the first puncturing pattern and a second puncturing pattern mapped to a second demodulation reference signal sequence indicate, in the mapping table, puncturing of the same number of physical resource blocks but with different puncturing patterns, and wherein the means are configured to select the second demodulation reference signal sequence upon determining that said system information or other system information shall be transmitted by using the second puncturing pattern.

42. The apparatus of claim 40, wherein a second puncturing pattern mapped to a second demodulation reference signal sequence in the mapping table indicates that no puncturing shall be applied, and wherein the means are configured to select the second demodulation reference signal sequence upon determining that said system information or other system information shall be transmitted without puncturing.

43. The apparatus of claim 40 wherein the first puncturing pattern and a second puncturing pattern mapped to a second demodulation reference signal sequence indicate, in the mapping table, puncturing of the same number of physical resource blocks but with different puncturing patterns, and wherein the means are configured to select the second demodulation reference signal sequence upon determining that said system information or other system information shall be transmitted by using the second puncturing pattern, and wherein the first demodulation reference signal sequence further indicates a first synchronization signal block index of multiple possible synchronization signal block indices, the first synchronization signal block index indicating a first transmission beam where a synchronization signal block comprising the first demodulation reference signal shall be transmitted,
the second demodulation reference signal sequence further indicates a second synchronization signal block index of said multiple possible synchronization signal block indices, the second synchronization signal block index indicating a second transmission beam where a synchronization signal block comprising the second demodulation reference signal shall be transmitted, and
the apparatus is configured to transmit the system information and the first demodulation reference signal sequence in the first transmission beam and in the synchronization signal block having the first synchronization signal block index.

44. The apparatus of claim 40, wherein a second puncturing pattern mapped to a second demodulation reference signal sequence in the mapping table indicates that no puncturing shall be applied, and wherein the means are configured to select the second demodulation reference signal sequence upon determining that said system information or other system information shall be transmitted without puncturing,
and wherein the first demodulation reference signal sequence further indicates a first synchronization signal block index of multiple possible synchronization signal block indices, the first synchronization signal block index indicating a first transmission beam where a synchronization signal block comprising the first demodulation reference signal shall be transmitted,
the second demodulation reference signal sequence further indicates a second synchronization signal block index of said multiple possible synchronization signal block indices, the second synchronization signal block index indicating a second transmission beam where a synchronization signal block comprising the second demodulation reference signal shall be transmitted, and
the apparatus is configured to transmit the system information and the first demodulation reference signal sequence in the first transmission beam and in the synchronization signal block having the first synchronization signal block index.

45. The apparatus of claim 40, wherein the system information comprises a master information block indicating a control resource set for a physical downlink control channel, and wherein the means are configured to transmit control information for further system information on the physical downlink control channel by using the same puncturing pattern as used for transmitting the master information block.

46. The apparatus of claim 40, wherein the mapping table maps each demodulation reference signal sequence of the mapping table to a unique combination of a puncturing pattern and at least one of a synchronization signal block index, a half-frame index, and a channel bandwidth.

47. The apparatus of claim 40, wherein the mapping table maps each demodulation reference signal sequence of the mapping table to a unique combination of a puncturing pattern and at least one of a synchronization signal block index, a half-frame index, and a channel bandwidth, and wherein the mapping table maps each demodulation reference signal sequence of the mapping table to a unique combination of the puncturing pattern, the synchronization signal block index, and the half-frame index, and wherein one of the synchronization signal block index and the half-frame index is the same for all demodulation reference signal sequences of the mapping table and the other one of the synchronization signal block index and the half-frame index varies between demodulation reference signal sequences of the mapping table.

48. The apparatus of claim 40, wherein the mapping table maps each demodulation reference signal sequence of the mapping table to a unique combination of a puncturing pattern and at least one of a synchronization signal block index, a half-frame index, and a channel bandwidth, and wherein the mapping table maps at least four different puncturing patterns, comprising no puncturing.

49. An apparatus comprising at least one processor and at least one memory storing instructions that cause the apparatus to:
store a mapping table comprising mapping information on demodulation reference signal sequences to puncturing patterns, the mapping information mapping a first demodulation reference signal sequence to a first puncturing pattern indicating a first set of punctured physical resource blocks, and at least a second demodulation reference signal sequence to a second puncturing pattern indicating a second set of punctured physical resource blocks;
receive a signal comprising a demodulation reference signal sequence and system information and detecting the demodulation reference signal sequence;
if the demodulation reference signal sequence is detected as the first demodulation reference signal sequence, detect the system information on a set of physical resource blocks defining a first frequency band that excludes the first set of punctured physical resource blocks; and
if the demodulation reference signal sequence is detected as the second demodulation reference signal sequence, detect the system information on a set of physical resource blocks defining a second frequency band that excludes the second set of punctured physical resource blocks.

50. The apparatus of claim 49, wherein the first puncturing pattern and second puncturing pattern indicate puncturing of the same number of punctured physical resource blocks.

51. The apparatus of claim 49, wherein the second puncturing pattern indicates that no puncturing shall be applied, and wherein the second frequency band is thus broader than the first frequency band.

52. The apparatus of claim 49, wherein the system information comprises a master information block indicating a control resource set for a physical downlink control channel, and wherein the means are configured to detect control information for further system information on physical resource blocks of the physical downlink control channel by using the same puncturing pattern as used for detecting the master information block.

53. The apparatus of 49, wherein:
the first demodulation reference signal sequence further indicates a first synchronization signal block index of multiple possible synchronization signal block indices, the first synchronization signal block index indicating a first transmission beam where a synchronization signal block comprising the first demodulation reference signal shall be transmitted,
the second demodulation reference signal sequence further indicates a second synchronization signal block index of said multiple possible synchronization signal block indices, the second synchronization signal block index indicating a second transmission beam where a synchronization signal block comprising the second demodulation reference signal shall be transmitted.

54. The apparatus of claim 49, wherein the first demodulation reference signal sequence further indicates a first synchronization signal block index of multiple possible synchronization signal block indices, the first synchronization signal block index indicating a first transmission beam where a synchronization signal block comprising the first demodulation reference signal shall be transmitted,
the second demodulation reference signal sequence further indicates a second synchronization signal block index of said multiple possible synchronization signal block indices, the second synchronization signal block index indicating a second transmission beam where a synchronization signal block comprising the second demodulation reference signal shall be transmitted, and
wherein the number of said multiple possible synchronization signal block indices is a multiple greater than one of a number of different transmission beams where the synchronization signal block can be transmitted, and wherein the mapping table provides a mapping between the multiple possible synchronization signal block indices and respective puncturing patterns comprising the first puncturing pattern and the second puncturing pattern,

55. The apparatus of claim 49, wherein the mapping table maps each demodulation reference signal sequence of the mapping table to a unique combination of a puncturing pattern and at least one of a synchronization signal block index, a puncturing pattern, a half-frame index, and a channel bandwidth.

56. The apparatus of claim 49, wherein the mapping table maps each demodulation reference signal sequence of the mapping table to a unique combination of a puncturing pattern and at least one of a synchronization signal block index, a puncturing pattern, a half-frame index, and a channel bandwidth, and wherein the mapping table maps each demodulation reference signal sequence of the mapping table to a unique combination of the puncturing pattern, the synchronization signal block index, and the half-frame index, and wherein one of the synchronization signal block index and the half-frame index is the same for all demodulation reference signal sequences of the mapping table and the other one of the synchronization signal block index and the half-frame index varies between demodulation reference signal sequences of the mapping table.

57. The apparatus of claim 49, wherein the mapping table maps each demodulation reference signal sequence of the mapping table to a unique combination of a puncturing pattern and at least one of a synchronization signal block index, a puncturing pattern, a half-frame index, and a channel bandwidth, and wherein the mapping table maps at least four different puncturing patterns, comprising no puncturing.

58. A method comprising:
storing a mapping table comprising mapping information on demodulation reference signal sequences to puncturing patterns;
determining, based on available bandwidth, that puncturing shall be applied to transmission of a system information block in order to fit the system information block to a frequency band having the available bandwidth;
selecting, from the puncturing patterns, a first puncturing pattern to puncture at least one physical resource block to provide the available bandwidth for transmitting the system information block;
selecting, on the basis of the mapping table, a first demodulation reference signal sequence mapped to the selected first puncturing pattern in the mapping table; and
transmitting the system information block and the first demodulation reference signal sequence by using the available bandwidth.

59. The method of claim 58, wherein the first puncturing pattern and a second puncturing pattern mapped to a second demodulation reference signal sequence indicate, in the mapping table, puncturing of the same number of physical resource blocks but with different puncturing patterns, and wherein the method comprises selecting the second demodulation reference signal sequence upon determining that said system information or other system information shall be transmitted by using the second puncturing pattern.

60. The method of claim 58, wherein a second puncturing pattern mapped to a second demodulation reference signal sequence in the mapping table indicates that no puncturing shall be applied, and wherein the method comprises selecting the second demodulation reference signal sequence upon determining that said system information or other system information shall be transmitted without puncturing.

61. The method of claim 58, wherein the system information comprises a master information block indicating a control resource set for a physical downlink control channel, and wherein the method comprises transmitting control information for further system information on the physical downlink control channel by using the same puncturing pattern as used for transmitting the master information block.

62. The method of claim 59, wherein the mapping table maps each demodulation reference signal sequence of the mapping table to a unique combination of a puncturing pattern and at least one of a synchronization signal block index, a half-frame index, and a channel bandwidth.
